(19) United States
(12) Patent Application Publication
(10) Pub. No.: US 2025/0145134 A1
(43) Pub. Date: May 8, 2025

(54) BRAKE SYSTEM FOR VEHICLE

(71) Applicant: HL MANDO CORPORATION, Gyeonggi-do (KR)

(72) Inventors: Hyundong KIM, Gyeonggi-do (KR); Sooyong JEON, Gyeonggi-do (KR); Yeonseong KIM, Gyeonggi-do (KR); Heejun KIM, Gyeonggi-do (KR); Sungjun HONG, Gyeonggi-do (KR)

(21) Appl. No.: 18/935,364

(22) Filed: Nov. 1, 2024

(30) Foreign Application Priority Data
Nov. 7, 2023 (KR) 10-2023-0153140
Jun. 27, 2024 (KR) 10-2024-0084531

(51) Int. Cl. B60T 13/58; B60T 8/40; B60T 13/14; B60T 13/62; B60T 13/68; B60T 13/74; B60T 17/22; G05G 5/05

(52) U.S. Cl. CPC B60T 13/588; B60T 8/409; B60T 13/142; B60T 13/148; B60T 13/62; B60T 13/686; B60T 13/746; B60T 17/22; B60T 2220/04; B60T 2270/402; B60T 2270/404; G05G 5/05; G05G 2505/00

(57) ABSTRACT

A brake system for a vehicle include first brake devices respectively provided in two vehicle wheels of a vehicle and configured to perform a braking operation by transmitted liquid pressure, second brake devices respectively provided in the other two vehicle wheels of the vehicle and configured to perform a braking operation by an embedded second electromechanical actuator, a reservoir, a master cylinder including a master chamber, and a master piston provided in the master chamber, a hydraulic actuator configured to generate the liquid pressure by an electrical signal outputted in response to a displacement amount of the brake pedal, a hydraulic circuit configured to control the liquid pressure to be transmitted to the first brake device, and an electronic control unit configured to control the first electromechanical actuator, the hydraulic actuator, and the hydraulic circuit so that the first brake device and the second brake device generate braking forces.

### CROSS-REFERENCE TO RELATED APPLICATIONS

This application claims the priority of Korean Patent Application No. 10-2023-0153140 filed on Nov. 7, 2023, in the Korean Intellectual Property Office and the priority of Korean Patent Application No. 10-2024-0084531 filed on Jun. 27, 2024, in the Korean Intellectual Property Office, the disclosures of which are incorporated herein by reference.

### BACKGROUND

### Field

The disclosed disclosure relates to a brake system for a vehicle, and more particularly, to a brake system for a vehicle in which a hydraulic brake device and an electromechanical brake device are combined, such that ABS/ESC performance may be implemented, and braking may be performed even in a breakdown situation.

### Description of the Related Art

A vehicle is essentially equipped with a brake system for braking the vehicle. Various types of brake systems have been proposed to provide safety for a driver and a passenger.

The brake system in the related art mainly operates in such a way that when the driver pushes a brake pedal, a booster mechanically connected to the brake pedal is used to supply a wheel cylinder with a liquid pressure required to brake the vehicle. In contrast, recently, an electromechanical brake (EMB) system has been developed as a next-generation brake system, and the electromechanical brake (EMB) system provides a braking force for a vehicle by receiving a driver's braking intention as an electrical signal and operating an electric device such as a motor in response to the driver's braking intention.

The electromechanical brake system provides a clamping force for a brake disc by converting a rotational force of the motor into a linear motion by means of the motor, a speed reducer, and the like and performs service braking and parking braking on the vehicle.

However, because the electromechanical brake system is operated by electric power, the electromechanical brake system has difficulty in coping with a situation, such as single fault fail, in which electric power is not supplied because of an abnormal power source of the vehicle. Because a reaction speed of an actuator configured to operate the electromechanical brake system is lower than that of a hydraulic brake system, it is difficult to control an anti-lock brake system (ABS), electronic stability control (ESC), and the like.

### SUMMARY

An object to be achieved by the present disclosure is to provide a brake system for a vehicle, in which a hydraulic brake device and an electromechanical brake device are combined, such that ABS/ESC performance may be implemented, and braking may be performed even in a breakdown situation.

A brake system for a vehicle according to one aspect of the disclosed disclosure may include first brake devices respectively provided in two vehicle wheels of a vehicle and configured to perform a braking operation by transmitted liquid pressure, second brake devices respectively provided in the other two vehicle wheels of the vehicle and configured to perform a braking operation by an embedded first electromechanical actuator, a reservoir configured to store a pressing medium, a master cylinder including a master chamber, and a master piston provided in the master chamber and provided to be displaceable by a brake pedal, a hydraulic actuator configured to generate the liquid pressure by an electrical signal outputted in response to a displacement amount of the brake pedal, a hydraulic circuit configured to control the liquid pressure to be transmitted to the first brake device, and an electronic control unit configured to control the electromechanical actuator, the hydraulic actuator, and the hydraulic circuit so that the first brake device and the second brake device generate braking forces in response to the displacement amount of the brake pedal.

The brake system may further include: a pedal simulator configured to provide a reaction force in response to a pedal effort of the brake pedal.

The master cylinder may further include an elastic member provided in the master chamber and configured to provide a reaction force to the master piston in response to a pedal effort of the brake pedal.

The first brake device may be provided in each of two front wheels of the vehicle, and the second brake device may be provided in each of two rear wheels of the vehicle.

The first brake device may be provided in each of the two rear wheels of the vehicle, and the second brake device may be provided in each of the two front wheels of the vehicle.

The first brake device may perform the braking operation by any one of the transmitted liquid pressure and an embedded second electromechanical actuator.

The first brake device may be an electric drum brake.

The first brake device may perform the braking operation simultaneously by the transmitted liquid pressure and the embedded second electromechanical actuator.

The hydraulic actuator may include a drive part, and a piston-cylinder unit configured to be operated by power of the drive part. The piston-cylinder unit may include an actuator cylinder, an actuator piston connected to the drive part, accommodated in a bore in the actuator cylinder, and configured to slide, and first chamber and a second chamber formed between the actuator piston and the actuator cylinder.

The hydraulic circuit may include a plurality of valves disposed in a flow path that connects the hydraulic actuator and the first brake device, and the electronic control unit may control the plurality of valves to generate the braking force by transmitting the pressing medium, which is discharged from the hydraulic actuator, to the first brake device on the basis of the displacement amount of the brake pedal.

The plurality of valves may include a plurality of normal-open type solenoid valves and a plurality of normal-closed type solenoid valves respectively provided at upstream and downstream sides of the first brake device and configured to control the flow of the liquid pressure.

The brake system may further include: a back-up flow path connected to supply the pressing medium, which is discharged from the master cylinder, to the first brake device; and a cut valve provided in the back-up flow path.

The cut valve may be provided as a normal-open type solenoid valve.

The back-up flow path may be connected to the hydraulic circuit.

The electronic control unit may switch the cut valve to a closed state in a normal operating state.

The brake system may further include: a pedal simulator configured to provide a reaction force in response to a pedal effort of the brake pedal; and a simulator valve provided in a branch flow path configured to connect the pedal simulator and the master cylinder, in which the electronic control unit switches the simulator valve to an open state when a driver applies the pedal effort to the brake pedal.

The brake system may further include: a simulator valve provided in a simulation flow path configured to connect the back-up flow path and the reservoir, in which the master cylinder may further include an elastic member provided in the master chamber and configured to provide a reaction force to the master piston in response to a pedal effort of the brake pedal, and in which the electronic control unit switches the simulator valve to an open state when a driver applies the pedal effort to the brake pedal.

The simulation flow path may be connected to the back-up flow path between the cut valve and the master cylinder.

The simulator valve may be provided as a normal-closed type solenoid valve.

The electronic control unit may switch the simulator valve to a closed state while an inspection mode is performed in which the simulator valve is inspected for a leak.

The brake system may further include a simulator check valve installed in parallel with the simulator valve.

The brake system may further include: a reservoir flow path configured to allow the reservoir and the master cylinder to communicate with each other; a reservoir check valve provided in the reservoir flow path; a bypass flow path configured to connect front and rear sides of the reservoir check valve; and an inspection valve provided in the bypass flow path.

The electronic control unit may switch the inspection valve to a closed state while an inspection mode is performed in which the inspection valve is inspected for a leak.

A brake system for a vehicle according to another aspect of the disclosed disclosure may include: first brake devices respectively provided in two vehicle wheels of a vehicle and configured to perform a braking operation by transmitted liquid pressure; second brake devices respectively provided in the other two vehicle wheels of the vehicle and configured to perform a braking operation by an embedded electromechanical actuator; a reservoir configured to store a pressing medium; a master cylinder including a master chamber, and a master piston provided in the master chamber and provided to be displaceable by a brake pedal; a hydraulic actuator configured to generate the liquid pressure by an electrical signal outputted in response to a displacement amount of the brake pedal; a hydraulic circuit configured to control the liquid pressure to be transmitted to the first brake device; a first electronic control unit configured to control the hydraulic actuator and the hydraulic circuit so that the first brake device generates a braking force in response to the displacement amount of the brake pedal; and a second electronic control unit configured to control the electromechanical actuator so that the second brake device generates a braking force in response to the displacement amount of the brake pedal.

A brake system for a vehicle according to still another aspect of the disclosed disclosure may include: a hydraulic actuator hydraulically connected to a first brake device provided in a first wheel related to a first axle of a vehicle; a first motor configured to operate the hydraulic actuator; a power transmission mechanism mechanically connected to a second brake device provided in a second wheel related to a second axle different from the first axle; a second motor configured to operate the power transmission mechanism; a first control unit configured to control the first motor to supply liquid pressure to the first brake device or recover the liquid pressure on the basis that an output signal of a pedal displacement sensor of the vehicle is received; and a second control unit configured to control the second motor to operate or release the second brake device in response to a control signal on the basis of the output signal of the pedal displacement sensor of the vehicle, in which the first control unit is connected directly to the pedal displacement sensor, and in which the second control unit is not connected directly to the pedal displacement sensor.

The second control unit may receive the control signal from the first control unit.

The second control unit may receive the control signal from a third control unit provided in the vehicle.

The first brake device may be operated or released by the liquid pressure supplied or recovered by the hydraulic actuator.

The brake system may further include: another power transmission mechanism mechanically connected to the first brake device; a third motor configured to operate another power transmission mechanism; and a third control unit configured to control the third motor to operate or release the first brake device in response to a control signal on the basis of the output signal of the pedal displacement sensor of the vehicle, in which the third control unit is not connected directly to the pedal displacement sensor.

The first brake device may be operated or released by the liquid pressure supplied or recovered by the hydraulic actuator, and the first brake device may be operated or released by another power transmission mechanism.

The brake system according to the embodiment of the disclosed disclosure brakes some of the vehicle wheels by the hydraulic actuators, such that the high reaction speed may be implemented, thereby improving ABS, TCS, and ESC control performance.

According to the brake system according to the embodiment of the disclosed disclosure, some of the vehicle wheels are connected directly to the master cylinder through the back-up flow path, such that the braking force may be generated even in a breakdown situation of the brake system.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a hydraulic circuit diagram illustrating a brake system according to a first embodiment of the disclosed disclosure;

FIG. 2 is an enlarged view illustrating a hydraulic actuator according to the first embodiment of the disclosed disclosure;

FIG. 3 is a hydraulic circuit diagram illustrating a state in which the brake system according to the first embodiment of the disclosed disclosure performs braking by an electromechanical actuator;

FIG. 4 is a hydraulic circuit diagram illustrating a state in which the brake system according to the first embodiment of the disclosed disclosure performs braking by a hydraulic actuator and the electromechanical actuator;

FIG. 5 is a hydraulic circuit diagram illustrating a state in which a fallback mode in which the brake system according to the first embodiment of the disclosed disclosure is not normally operated is performed;

FIG. 6 is a hydraulic circuit diagram illustrating a state in which an inspection mode in which the brake system according to the first embodiment of the disclosed disclosure inspects a valve for a leak is performed;

FIG. 7 is a hydraulic circuit diagram illustrating a brake system according to a second embodiment of the disclosed disclosure;

FIG. 8 is a hydraulic circuit diagram illustrating a state in which a fallback mode in which the brake system according to the second embodiment of the disclosed disclosure is not normally operated is performed;

FIG. 9 is a hydraulic circuit diagram illustrating a brake system according to a third embodiment of the disclosed disclosure;

FIG. 10 is a cross-sectional side view illustrating a first brake device according to the third embodiment of the disclosed disclosure; and

FIG. 11 is a cross-sectional side view illustrating a second brake device according to the third embodiment of the disclosed disclosure.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Like reference numerals indicate like constituent elements throughout the specification. This specification does not describe all elements of the disclosed embodiments and detailed descriptions of what is well known in the art or redundant descriptions on substantially the same configurations have been omitted. The terms ‘part’, ‘module’, ‘member’, ‘block’ and the like as used in the specification may be implemented in software or hardware. Further, a plurality of ‘part’, ‘module’, ‘member’, ‘block’ and the like may be embodied as one component. It is also possible that one ‘part’, ‘module’, ‘member’, ‘block’ and the like includes a plurality of components.

Throughout the present specification, when one constituent element is referred to as being “connected to” another constituent element, one constituent element can be “directly connected to” the other constituent element, and one constituent element can also be “indirectly connected to” the other constituent element. The indirect connection includes a connection through a wireless communication network.

In addition, unless explicitly described to the contrary, the word “comprise/include” and variations such as “comprises/includes” or “comprising/including” will be understood to imply the inclusion of stated elements, not the exclusion of any other elements.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, operation principles and embodiments of the disclosed disclosure will be described in detail with reference to the accompanying drawings.

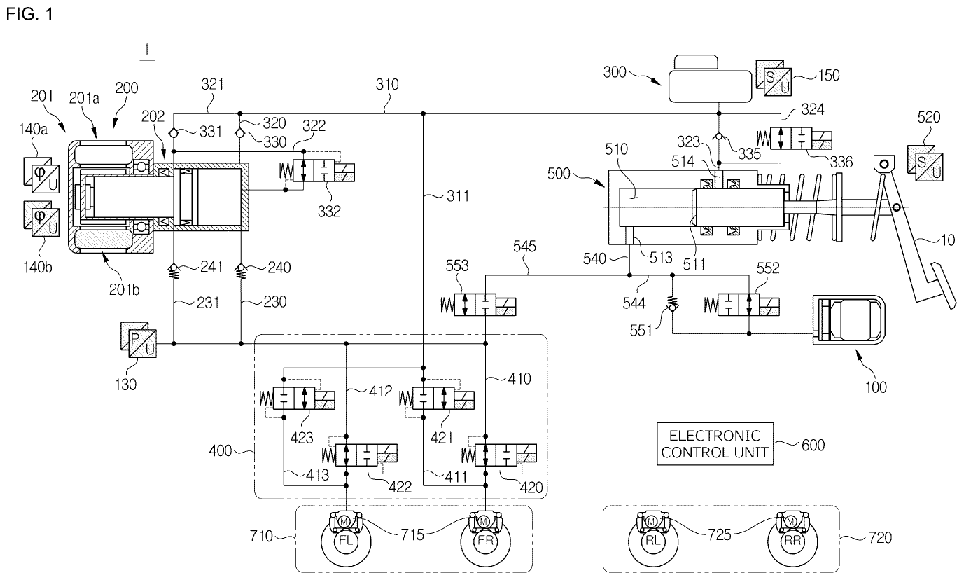

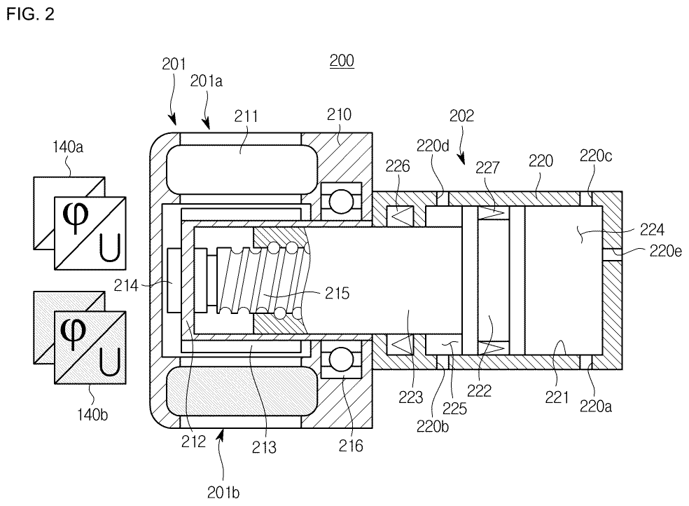

FIG. 1 is a hydraulic circuit diagram illustrating a brake system 1 according to a first embodiment of the disclosed disclosure, and FIG. 2 is an enlarged view illustrating a hydraulic actuator 200 according to the first embodiment of the disclosed disclosure.

With reference to FIG. 1, the brake system 1 includes the hydraulic actuator 200 configured to generate liquid pressure, a reservoir 300 connected to the hydraulic actuator 200 and configured to store a pressing medium, a master cylinder 500 connected to a brake pedal 10, a pedal displacement sensor 520 configured to detect a displacement of the brake pedal 10, a pedal simulator 100 configured to provide a reaction force in response to a pedal effort of the brake pedal 10, a first brake device 710 configured to perform an operation of braking two vehicle wheels by receiving the liquid pressure, a second brake device 720 configured to perform an operation of braking the other two vehicle wheels by an embedded first electromechanical actuator 725, and a hydraulic circuit 400 configured to control the liquid pressure to be transmitted to the first brake device 710.

The first brake device 710 may perform the braking operation by using the liquid pressure. For example, the first brake device 710 may be a disc brake device and may perform the braking operation by pressing a brake pad against a brake disc by the liquid pressure transmitted to a wheel cylinder.

Meanwhile, in the first embodiment of the disclosed disclosure, the first brake device 710 may perform the braking operation by any one of the transmitted liquid pressure and an embedded second electromechanical actuator 715. For example, the first brake device 710 may be a disc brake in which a motor-spindle device is provided in the wheel cylinder supplied with the liquid pressure, and the braking is performed as the spindle device is advanced by the transmitted liquid pressure or an operation of a motor.

Alternatively, in another embodiment, the first brake device 710 may be an electric drum brake. The electric drum brake may perform a braking operation by pressing a brake shoe against a brake drum by liquid pressure supplied to a wheel cylinder provided therein or perform a braking operation by pressing the brake shoe by the motor-spindle device.

The second brake device 720 may perform the braking operation by the embedded first electromechanical actuator 725. For example, the second brake device 720 may be a disc brake in which a motor-spindle device is provided as an electromechanical brake (EMB), and the braking is performed as a spindle device is advanced by an operation of a motor.

Alternatively, in another embodiment, the second brake device 720 may be an electric drum brake. The electric drum brake perform a braking operation by pressing a brake shoe by a motor-spindle device provided therein.

The first brake device 710 may be provided in a first wheel related to a first axle of the vehicle, and the second brake device 720 may be provided in a second wheel related to a second axle different from the first axle. In the present embodiment, as illustrated in FIG. 1, the first brake devices 710 may be respectively provided in two front wheels FL and FR of the vehicle, and the second brake devices 720 may be respectively provided in two rear wheels RL and RR of the vehicle.

However, the present disclosure is not limited thereto. In another embodiment, the first brake devices 710 may be respectively provided in the two rear wheels RL and RR of the vehicle, and the second brake devices 720 may be respectively provided in the two front wheels FL and FR of the vehicle.

As described above, in the brake system 1 according to the first embodiment of the disclosed disclosure, the first brake devices 710, which are capable of performing braking by provided hydraulic pressure, are provided in the two vehicle wheels, and the second brake devices 720, which are capable of performing braking by electromechanical actuators, are provided in the other two vehicle wheels, such that braking performance may be improved, and the vehicle may be braked even when the device is broken down.

With reference to FIG. 2, the hydraulic actuator 200 includes a drive part 201, and a piston-cylinder unit 202 operated by power of the drive part 201. The drive part 201 may generate power in response to an electrical signal of the pedal displacement sensor 520, i.e., an electrical signal outputted in response to a displacement amount of the brake pedal 10. The piston-cylinder unit 202 may generate liquid pressure by power of the drive part 201 and provide braking pressure to the first brake device 710.

The pedal displacement sensor 520 detects a displacement of the brake pedal 10 and transmits an electrical signal to an electronic control unit (ECU) 600. Further, the electronic control unit 600 may identify braking pressure required by the driver by analyzing a signal of the pedal displacement sensor 520 and outputs signals for controlling the piston-cylinder unit 202 and various types of valves to satisfy the braking pressure.

The drive part 201 includes a first motor 210 configured to generate a rotational force by being supplied with electric power. The first motor 210 may be a device for generating a rotational force in response to a signal outputted from the electronic control unit 600 and may generate the rotational force in a forward direction or a reverse direction. A rotation angular velocity and a rotation angle of the motor 210 may be precisely controlled. Because the first motor 210 is a technology already publicly known widely, a detailed description thereof will be omitted.

The first motor 210 includes a stator 211 and a rotor 212. The stator 211 may be provided in a ring or doughnut shape that defines a hollow portion, and the rotor 212 may be disposed in the hollow portion of the stator 211 and provided in a hollow cylindrical shape.

Further, the drive part 201 includes at least one magnetic element 213 to allow the first motor 210 to generate a rotational force. The magnetic element 213 may be disposed on an outer peripheral surface of the rotor 212 and rotate together with the rotor 212. Further, a gap may be formed between the stator 211 and the magnetic element 213 and allow the rotor 212 to rotate without interference.

Further, the drive part 201 may further include a ball bearing 216 interposed between the first motor 210 and the rotor 212. The ball bearing 216 may be installed on an inner peripheral surface of a hollow portion of the first motor 210 and guide the rotation of the rotor 212.

Further, the drive part 201 includes a power transmission part configured to convert a rotational motion of the first motor 210 into a rectilinear motion and transmit the rectilinear motion to an actuator piston 222. The power transmission part may include a pin member 214 coupled to the rotor 212 and configured to rotate together with the pin member 214, and a rotary shaft member 215 connected to the pin member 214 and configured to rotate. For example, the rotor 212 may be formed in a hollow cylindrical shape, a surface may be formed at one end of the rotor 212, and the pin member 214 may be coupled to an end surface of the rotor 212.

The piston-cylinder unit 202 may include a cylinder block, an actuator cylinder 220 having a bore 221 formed in the cylinder block, a piston rod 223 gear-coupled to the rotary shaft member 215 and configured to rectilinearly reciprocate, the actuator piston 222 connected to the piston rod 223, accommodated in the bore 221, and provided to be slidable, and chambers 224 and 225 provided between the actuator piston 222 and the actuator cylinder 220.

The actuator cylinder 220 may be connected to one side of the first motor 210. Alternatively, the actuator cylinder 220 may be integrated with the first motor 210. The actuator cylinder 220 may have the bore 221 that is a hollow portion that accommodates the actuator piston 222.

Further, the bore 221 may extend in parallel with a rotation axis direction of the first motor 210. That is, the actuator piston 222 may rectilinearly reciprocate in the direction parallel to the rotation axis of the first motor 210.

The piston rod 223 may be a nut member nut-screw-coupled to the rotary shaft member 215. For example, the rotary shaft member 215 may define a screw having an outer peripheral surface on which a screw thread is formed. The piston rod 223 may include a hollow portion, and a screw groove may be formed in an inner peripheral surface of the hollow portion and screw-coupled to the rotary shaft member 215. That is, a rotational motion of the rotary shaft member 215 may be converted into a rectilinear reciprocating motion of the piston rod 223.

Meanwhile, the rotary shaft member 215 and the piston rod 223 may be coupled by a ball-screw engagement in which rolling balls are interposed between the screw thread and the screw groove.

Further, one side of the actuator cylinder 220 is opened to communicate with the bore 221. Further, the piston rod 223 may penetrate and enter the opening portion of the actuator cylinder 220.

Further, an inner diameter of the opening portion of the actuator cylinder 220 may be smaller than an inner diameter of the bore 221, and an outer diameter of the actuator piston 222 may be larger than an outer diameter of the piston rod 223. Therefore, it is possible to prevent the actuator piston 222 from being withdrawn from the bore 221 to the outside.

The piston-cylinder unit 202 may include a reciprocating piston. That is, the piston-cylinder unit 202 may include a first chamber 224 positioned forward of the actuator piston 222, and a second chamber 225 positioned rearward of the actuator piston 222.

The first chamber 224 and the second chamber 225 may each be connected to the first brake device 710 and provide liquid pressure. The liquid pressure, which is formed in the first chamber 224 as the actuator piston 222 is advanced, is transmitted to the first brake device 710 through a first hydraulic flow path 230, and the liquid pressure, which is formed in the second chamber 225 as the actuator piston 222 is retracted, may be transmitted to the first brake device 710 through a second hydraulic flow path 231.

In addition, the first and second chambers 224 and 225 may each be connected to the first brake device 710 and remove the liquid pressure. The pressing medium of the first brake device 710 is introduced into the first chamber 224 through the first hydraulic flow path 230 by negative pressure formed in the first chamber 224 as the actuator piston 222 is retracted. The pressing medium of the first brake device 710 may be introduced into the second chamber 225 through the second hydraulic flow path 231 by negative pressure formed in the second chamber 225 as the actuator piston 222 is advanced.

Meanwhile, in case that the actuator piston 222 is advanced, the liquid pressure may be generated in the first chamber 224, or the negative pressure may be generated in the second chamber 225. On the contrary, in case that the actuator piston 222 is retracted, the negative pressure may be generated in the first chamber 224, or the liquid pressure may be generated in the second chamber 225. In this case, the electronic control unit 600 may control valves to determine whether to provide braking pressure to the first brake device 710 by using the liquid pressure in the chamber or whether to release braking pressure by using the negative pressure in chamber.

The first chamber 224 is defined by the actuator cylinder 220 and a front end of the actuator piston 222, and a volume of the first chamber 224 varies depending on the movement of the actuator piston 222. The second chamber 225 is defined by the actuator cylinder 220 and a rear end of the actuator piston 222, and a volume of the second chamber 225 varies depending on the movement of the actuator piston 222.

Further, the actuator piston 222 may be provided such that a first effective area in which the liquid pressure is formed in the first chamber 224 is larger than a second effective area in which the liquid pressure is formed in the second chamber 225. That is, the second effective area may have a value made by subtracting a cross-sectional area of the piston rod 223 from a cross-sectional area of the actuator piston 222.

Further, the piston-cylinder unit 202 may further include a first sealing member 226 configured to prevent the pressing medium of the second chamber 225 from leaking along the piston rod 223. The first sealing member 226 may be installed on an inner peripheral surface of the opening portion of the actuator cylinder 220. For example, a ring-shaped recessed groove is provided in the inner peripheral surface of the opening portion of the actuator cylinder 220, and the ring-shaped first sealing member 226 may be fitted with the recessed groove.

Further, the piston-cylinder unit 202 may further include a second sealing member 227 configured to seal the first chamber 224 and the second chamber 225. The second sealing member 227 may be installed on an outer peripheral surface of the actuator piston 222 and move together with the actuator piston 222. For example, flange shapes may be provided at front and rear ends of the actuator piston 222, and the ring-shaped second sealing member 227 may be fitted between the two flange shapes.

That is, the liquid pressure or negative pressure in the first chamber 224 generated by the advancement or retraction of the actuator piston 222 may be blocked by the second sealing member 227 and may not leak from the second chamber 225. The liquid pressure or negative pressure in the second chamber 225 generated by the retraction or advancement of the actuator piston 222 may be blocked by the first sealing member 226 and may not leak to the outside of the actuator cylinder 220.

The actuator cylinder 220 may include a first communication hole 220a configured to allow the first chamber 224 to communicate with the first hydraulic flow path 230 connected to the hydraulic circuit 400, and a second communication hole 220b configured to allow the second chamber 225 to communicate with the second hydraulic flow path 231 connected to the hydraulic circuit 400.

In addition, the actuator cylinder 220 may further include a third communication hole 220c configured to allow the first chamber 224 to communicate with a third reservoir flow path 320 connected to the reservoir 300, and a fourth communication hole 220d configured to allow the second chamber 225 to communicate with a fourth reservoir flow path 321 connected to the reservoir 300.

Further, the actuator cylinder 220 may further include a fifth communication hole 220e configured to allow the first chamber 224 to communicate with a balance flow path 322.

In addition, with reference back to FIG. 1, the first chamber 224 may be connected to the second chamber 225 through the balance flow path 322. A balance valve 332 may be installed in the balance flow path 322.

The balance valve 332 may be a solenoid valve configured to selectively allow a bidirectional flow of the pressing medium between the first chamber 224 and the second chamber 225. Further, the balance valve 332 may be a normal-closed type solenoid valve that is closed at ordinary times and operated to be opened when the balance valve 332 receives an opening signal from the electronic control unit 600.

Alternatively, the balance valve 332 may be provided as a normal-open type solenoid valve that is opened at ordinary times and operated to be closed when the balance valve 332 receives a closing signal of the electronic control unit 600.

The pressure in the first chamber 224 and the pressure in the second chamber 225 may become equal to each other by the balance flow path 322 and the balance valve 332. That is, the process of equalizing the pressure in the first chamber 224 and the pressure in the second chamber 225 by opening the balance valve 332 in which the pressure in the first chamber 224 and the pressure in the second chamber 225 are not uniform.

The brake system 1 may include the reservoir 300 connected to the hydraulic actuator 200 and configured to store the pressing medium.

The reservoir 300 may be connected to the hydraulic actuator 200 through a first reservoir flow path 310. Further, the first reservoir flow path 310 may include the third reservoir flow path 320 configured to supply the pressing medium to the first chamber 224 of the hydraulic actuator 200, and the fourth reservoir flow path 321 configured to supply the pressing medium to the second chamber 225. Alternatively, the third reservoir flow path 320 and the fourth reservoir flow path 321 may branch off from the first reservoir flow path 310.

Further, a first reservoir check valve 330, which allows a flow of the pressing medium only in a direction from the reservoir 300 to the first chamber 224, may be installed in the third reservoir flow path 320, and a second reservoir check valve 331, which allows a flow of the pressing medium only in a direction from the reservoir 300 to the second chamber 225, may be installed in the fourth reservoir flow path 321.

In addition, the reservoir 300 may be connected to the first brake device 710 through a second reservoir flow path 311. The connection between the reservoir 300 and the first brake device 710 may be controlled by first and second outlet valves 421 and 423.

In addition, the brake system 1 may include the hydraulic circuit 400 configured to control a flow of the liquid pressure to be transmitted to the first brake devices 710 provided in the two vehicle wheels, and the electronic control unit 600 configured to control the hydraulic actuator 200 and the valves on the basis of liquid pressure information and pedal displacement information.

The hydraulic circuit 400 may control the first brake device 710 by receiving the liquid pressure. The first brake devices 710 are installed in the two vehicle wheels and perform braking by receiving the liquid pressure.

The hydraulic circuit 400 may be connected to the first hydraulic flow path 230 and receive the liquid pressure from the hydraulic actuator 200. In the first embodiment illustrated in FIG. 1, the first hydraulic flow path 230 is divided into two flow paths connected to the wheel cylinder of the first brake device 710 of the right front wheel FR and the wheel cylinder of the first brake device 710 of the left front wheel FL.

In addition, the hydraulic circuit 400 may be connected to the second hydraulic flow path 231 and receive the liquid pressure from the hydraulic actuator 200. In this case, the second hydraulic flow path 231 may merge with the first hydraulic flow path 230.

The hydraulic circuit 400 may include a plurality of valves disposed in the flow path that connects the hydraulic actuator 200 and the first brake device 710. Specifically, the hydraulic circuit 400 may have a plurality of inlet valves 420 and 422 and the outlet valves 421 and 423 to control the liquid pressure during the braking process and the braking-releasing process.

In the hydraulic circuit 400, the first and second inlet valves 420 and 422, which control the liquid pressure to be transmitted to the first brake device 710, may be respectively installed in a first inlet flow path 410 and a second inlet flow path 412 branching off from the first hydraulic flow path 230.

Further, the inlet valves 420 and 422 may each be provided as a normal-open type solenoid valve that is disposed at an upstream side of the first brake device 710, opened at ordinary times, and operated to be closed when receiving a closing signal from the electronic control unit 600.

In addition, in the hydraulic circuit 400, the first and second outlet valves 421 and 423, which control the liquid pressure discharged from the first brake device 710, may be respectively installed in a first outlet flow path 411 and a second outlet flow path 413 branching off from the second reservoir flow path 311 and configured to connect downstream sides of the first and second inlet valves 420 and 422 and the reservoir 300.

Further, the outlet valves 421 and 423 may each be provided as a normal-closed type solenoid valve that is disposed at a downstream side of the first brake device 710, closed at ordinary times, and operated to be opened while receiving an opening signal from the electronic control unit 600.

The inlet valves 420 and 422 may be provided in the inlet flow paths 410 and 412 that connect the hydraulic actuator 200 and the first brake device 710. The inlet valves 420 and 422 may control the supply of the liquid pressure to the first brake devices 710 of the two vehicle wheels during the braking process. That is, the inlet valves 420 and 422 may control the pressure by being selectively opened when the required braking pressure of the first brake device 710 of each of the vehicle wheels is detected, and the braking is required.

In addition, the outlet valves 421 and 423 are provided in the outlet flow paths 411 and 413 connected to the second reservoir flow path 311 that connects the reservoir 300 and the first brake device 710. The outlet valves 421 and 423 may control the discharge of the liquid pressure from each of the vehicle wheels during the braking-releasing process. That is, outlet valves 421 and 423 may control the pressure by being selectively opened when the braking pressure of each of the vehicle wheels is detected, and decompressive braking is required.

The electronic control unit 600 may control the plurality of valves 420, 421, 422, and 423 provided in the hydraulic circuit 400 in order to generate the braking force by transmitting the pressing medium, which is discharged from the hydraulic actuator, to the first brake device on the basis of the displacement amount of the brake pedal 10.

The electronic control unit 600 may include a processor and a memory.

The memory may store programs for processing or controlling of the processor and various types of data for an operation of the brake system. The memory 34b may include not only volatile memories such as an S-RAM or a D-RAM, but also non-volatile memories such as a flash memory, a read-only memory (ROM) or an erasable programmable read-only memory (EPROM).

The processor may control an overall operation of the brake system 1.

In addition, the brake system 1 according to the first embodiment of the disclosed disclosure may further include a circuit liquid pressure sensor 130 configured to detect the liquid pressure of the hydraulic circuit 400. For example, the circuit liquid pressure sensor 130 may be connected to the first hydraulic flow path 230 or the second hydraulic flow path 231 and detect the liquid pressure.

In addition, the brake system 1 according to the first embodiment of the disclosed disclosure may further include driving displacement sensors 140a and 140b configured to detect the displacement of the drive part 201. For example, the driving displacement sensors 140a and 140b may detect a rotation angle of the first motor 210. Alternatively, the driving displacement sensors 140a and 140b may detect any one of a current, a voltage, and torque of the drive part 201.

In addition, the brake system 1 according to the first embodiment of the disclosed disclosure may further include a reservoir displacement sensor 150 configured to detect a liquid level of the reservoir 300.

The master cylinder 500 may include a master chamber 510, and a master piston 511 provided in the master chamber 510 and provided to be displaceable by the brake pedal 10.

In general, a tandem master cylinder having two chambers is used for the brake system. In contrast, in the embodiment of the disclosed disclosure, only the first brake devices 710 provided in the two wheels perform the braking by the liquid pressure, and the second brake devices 720 provided in the other two wheels perform the braking by the electromechanical actuator. Therefore, the master cylinder 500 may be provided as a single master cylinder having a single chamber.

The master chamber 510 communicates with a first hydraulic pressure port 513 and a second hydraulic pressure port 514, such that the pressing medium enters and exits the master chamber 510. For example, the first hydraulic pressure port 513 may be connected to a cylinder outlet flow path 540, and the second hydraulic pressure port 514 may be connected to a fifth reservoir flow path 323.

An input rod configured to press the master piston 511 of the master cylinder 500 may be in contact with and tightly attached to the master piston 511. That is, there may be no gap between the master cylinder 500 and the input rod. Therefore, when the brake pedal 10 is pushed, the master cylinder 500 may be directly pressed without an ineffective pedal stroke section.

The master chamber 510 may be connected to the reservoir 300 through the fifth reservoir flow path 323.

A third reservoir check valve 335 may be provided in the fifth reservoir flow path 323. The third reservoir check valve 335 may allow the flow of the pressing medium introduced into the master chamber 510 from the reservoir 300 and block the flow of the pressing medium introduced into the reservoir 300 from the master chamber 510. That is, the third reservoir check valve 335 may be provided to allow the flow of the fluid only in one direction. Further, front and rear sides of the third reservoir check valve 335 of the fifth reservoir flow path 323 may be connected by a bypass flow path 324. An inspection valve 336 may be provided in the bypass flow path 324.

The inspection valve 336 may be provided as a bidirectional control valve configured to control the flow of the pressing medium between the reservoir 300 and the master cylinder 500. The inspection valve 336 may be provided as a normal-open type solenoid valve that is opened at ordinary times and operated to be closed when a closing signal is transmitted from the electronic control unit 600 configured to perform overall control on the system. Specific functions and operations of the inspection valve 336 will be described below.

The pedal simulator 100 may be provided in a branch flow path 544 branching off from the cylinder outlet flow path 540 and provide a reaction force in response to a pedal effort of the brake pedal 10.

The pedal simulator 100 is provided in the branch flow path 544 in order to store the pressing medium discharged from the first hydraulic pressure port 513 of the master cylinder 500. A simulator valve 54 is provided at a front end of the pedal simulator 100 in the branch flow path 544.

The pedal simulator 100 may include a simulation chamber, a reaction force piston provided in the simulation chamber, and a spring damper device configured to elastically support the reaction force piston. The reaction force piston has a displacement in a predetermined range by the pressing medium introduced into the simulation chamber. The spring damper device may have various structures capable of storing an elastic force while being deformed in shape. For example, the spring damper device may include various members made of a material such as rubber or including a coil or plate shape to store the elastic force.

The pedal simulator 100 may provide a reaction force in response to the pedal effort applied to the brake pedal 10 by the driver. In addition, on the contrary, the pedal simulator 100 may provide a reaction force in response to a force for releasing the pedal effort applied to the brake pedal 10 by the driver.

The driver may finely adjust the braking force in accordance with the driver's intention by providing the reaction force to the extent that the pedal simulator 100 compensates for the pedal effort or the force for releasing the pedal effort provided by the driver.

A simulator valve 552 may connect the master cylinder 500 and the front end of the pedal simulator 100. The simulator valve 552 may include a normal-closed type solenoid valve that is kept in a closed state at ordinary times. The simulator valve 552 is opened when the driver applies the pedal effort to the brake pedal 10, thereby allowing the pressing medium to be introduced into the pedal simulator 100.

In addition, a simulator check valve 551 may be installed parallelly in the simulator valve 552. The simulator check valve 551 may ensure a quick return of the pressure of the pedal simulator 100 when the pedal effort of the brake pedal 10 is released.

An operation of the pedal simulator 100 will be described. When the driver provides the pedal effort to the brake pedal 10, the reaction force piston of the pedal simulator 100 compresses the spring damper device, such that the driver receives the pedal feel. Further, when the driver releases the pedal effort from the brake pedal 10, the spring damper device pushes the reaction force piston, and the reaction force piston returns to an original state.

In addition, the brake system 1 according to the first embodiment of the disclosed disclosure may include a back-up flow path 545 capable of supplying the pressing medium, which is discharged from the master cylinder 500, directly to the first brake device 710 when the brake system 1 operates abnormally. The back-up flow path 545 may branch off from the cylinder outlet flow path 540.

A cut valve 553, which controls the flow of the pressing medium, may be provided in the back-up flow path 545.

The cut valve 553 may be provided as a normal open-type solenoid valve that is opened in a normal state and operated to be closed when receiving a closing signal from the electronic control unit.

In addition, the back-up flow path 545 may connect the first hydraulic pressure port 513 and the hydraulic circuit 400.

The hydraulic circuit 400 may be connected to the back-up flow path 545 and receive the liquid pressure from the master cylinder 500.

In this case, the back-up flow path 545 may merge with the hydraulic circuit 400 at the upstream sides of the first and second inlet valves 420 and 422. Therefore, in case that the cut valve 553 is closed, the liquid pressure provided from the hydraulic actuator 200 may be supplied to the first brake device 710 through the hydraulic circuit 400. In case that the cut valve 553 is opened, the liquid pressure provided from the master cylinder 500 may be supplied to the first brake device 710 through the back-up flow path 545.

Hereinafter, an operation of the brake system 1 according to the first embodiment of the disclosed disclosure will be described in detail.

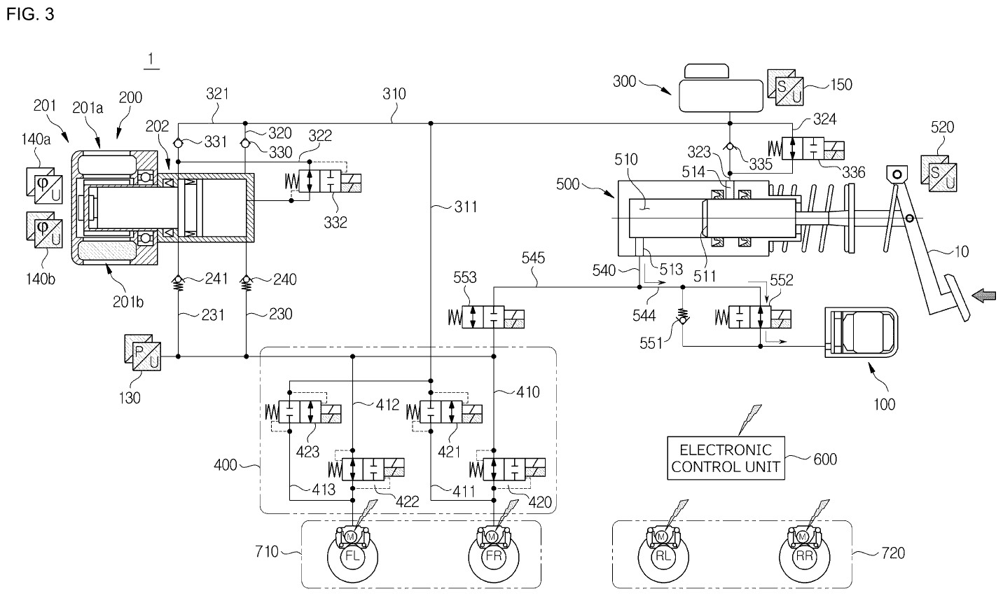

FIG. 3 is a hydraulic circuit diagram illustrating a state in which the brake system according to the first embodiment of the disclosed disclosure performs braking by the electromechanical actuator.

The brake system 1 according to the first embodiment of the disclosed disclosure may perform the braking by the electromechanical actuators provided in the first brake device 710 and the second brake device 720.

In case that both the first brake device 710 and the second brake device 720 of the brake system 1 perform the braking by the electromechanical actuators 715 and 725, the electronic control unit 600 operates the electromechanical actuators 715 and 725 in response to an electrical signal of the pedal displacement sensor 520, i.e., an electrical signal outputted in response to the displacement amount of the brake pedal 10. More specifically, the electronic control unit 600 generates a braking force by deriving target braking pressure in response to the electrical signal of the pedal displacement sensor 520, operating the electromechanical actuators 715 and 725 of the first brake device 710 and the second brake device 720 on the basis of the derived target braking pressure, and pressing a friction member against the rotor.

In this case, the electronic control unit 600 may switch the cut valve 553 to the closed state and prevent kick-back in which an impact is transmitted to the brake pedal 10 as the pressure in the master cylinder 500 is increased by the flow of the pressing medium in the wheel cylinder of the first brake device 710.

In addition, the electronic control unit 600 switches the simulator valve 552 to the open state, such that the hydraulic pressure, which is generated by the master cylinder 500 by the pedal effort of the brake pedal 10, is transmitted to the pedal simulator 100, and the pedal simulator 100 provides an appropriate reaction force.

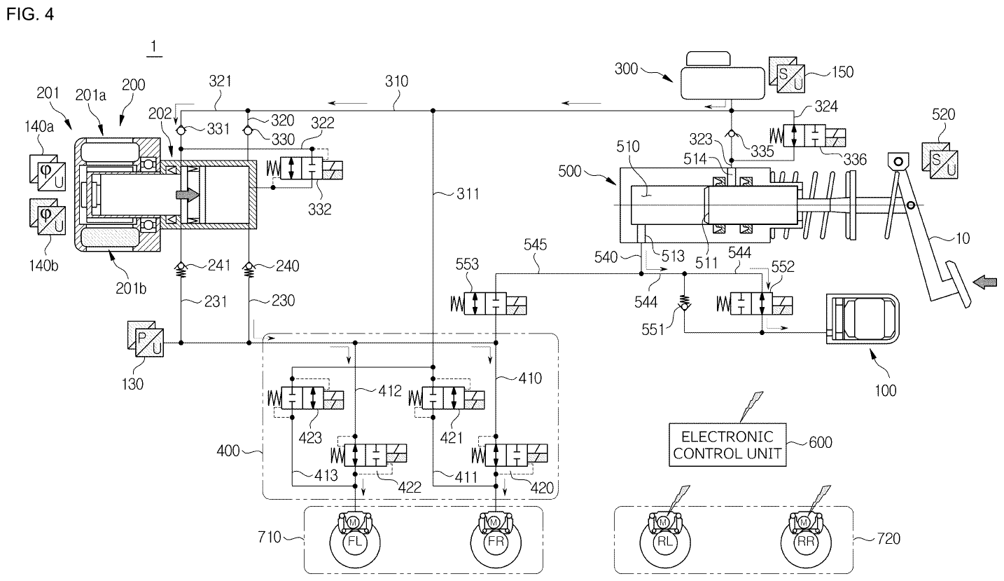

FIG. 4 is a hydraulic circuit diagram illustrating a state in which the brake system according to the first embodiment of the disclosed disclosure performs braking by the hydraulic actuator and the electromechanical actuator.

Meanwhile, the brake system 1 according to the first embodiment of the disclosed disclosure may perform the braking by simultaneously operating the hydraulic actuator 200 and the electromechanical actuators 715 and 725.

In case that the first brake device 710 of the brake system 1 performs the braking by the hydraulic actuator 200 and the second brake device 720 performs the braking by the electromechanical actuator 725, the electronic control unit 600 operates the hydraulic actuator 200, the hydraulic circuit 400, and the electromechanical actuator 725 in response to an electrical signal of the pedal displacement sensor 520, i.e., an electrical signal outputted in response to the displacement amount of the brake pedal 10. More specifically, the electronic control unit 600 derives the target braking pressure in response to an electrical signal of the pedal displacement sensor 520, generates the liquid pressure by operating the hydraulic actuator 200 on the basis of the derived target braking pressure, controls the opening or closing of the plurality of valves 420, 421, 422, and 423 provided in the hydraulic circuit 400 to transmit the generated liquid pressure to the first brake device 710, presses the friction member of the first brake device 710 against the rotor, and simultaneously presses the friction member against the rotor by operating the first electromechanical actuator 725 of the second brake device 720, thereby generating the braking force.

In the embodiment of the disclosed disclosure, the electronic control unit 600 may press the friction member of the first brake device 710 against the rotor by operating the second electromechanical actuator 715 while simultaneously supplying the liquid pressure from the hydraulic actuator 200 to the first brake device 710. To this end, the electronic control unit 600 may control the braking by deriving final target braking force of the first brake device 710 by deriving a target braking force by the hydraulic actuator 200 and deriving a target braking force by the second electromechanical actuator 715.

In the embodiment of the disclosed disclosure, the electronic control unit 600 may include a first electronic control unit (not illustrated) configured to control the hydraulic actuator 200 and the hydraulic circuit 400 so that the first brake device 710 generates the braking force in response to the displacement amount of the brake pedal 10, and a second electronic control unit (not illustrated) configured to control the first electromechanical actuator 725 so that the second brake device 720 generates the braking force in response to the displacement amount of the brake pedal 10. In the embodiment of the disclosed disclosure, the first and second electronic control units control the braking of the first brake device 710 and the second brake device 720, thereby safely performing the braking even when any one electronic control unit is broken down.

Meanwhile, the electronic control unit 600 may switch the cut valve 553 to the closed state and prevent kick-back in which an impact is transmitted to the brake pedal 10 as the pressure in the master cylinder 500 is increased by the flow of the pressing medium in the wheel cylinder of the first brake device 710. The electronic control unit 600 may prevent the liquid pressure, which is generated by the hydraulic actuator 200, from being transmitted to the master cylinder 500.

In addition, the electronic control unit 600 switches the simulator valve 552 to the open state, such that the hydraulic pressure, which is generated by the master cylinder 500 by the pedal effort of the brake pedal 10, is transmitted to the pedal simulator 100, and the pedal simulator 100 provides an appropriate reaction force.

The brake system 1 according to the first embodiment of the disclosed disclosure may effectively discharge only the braking pressure provided to the wheel cylinder of each of the first brake devices 710 through the first and second outlet valves 421 and 423.

For example, in case that the first and second inlet valves 420 and 422 switch to the closed state, the first outlet valve 421 is kept in the closed state, and the second outlet valve 423 switches to the open state, the liquid pressure discharged from the first brake device 710 installed in the left front wheel FL is discharged to the reservoir 300 through the second outlet valve 423.

The reason why the liquid pressure of the first brake device 710 is discharged through the outlet valves 421 and 423 is because the pressure in the reservoir 300 is lower than the pressure in the wheel cylinder of the first brake device 710. Typically, the pressure in the reservoir 300 is provided as atmospheric pressure. Typically, because the pressure in the wheel cylinder is significantly higher than atmospheric pressure, the liquid pressure in the wheel cylinder is quickly discharged to the reservoir 300 when the outlet valves 421 and 423 are opened.

Meanwhile, the liquid pressure may be supplied to the right front wheel FR in case that the second outlet valve 423 is opened to discharge the liquid pressure of the wheel cylinder of the corresponding first brake device 710 and the first inlet valve 420 switches to the open state.

As described above, the electronic control unit 600 independently controls the valves 420, 421, 422, and 423 of the hydraulic circuit 400 and selectively discharges the liquid pressure or transmits the liquid pressure to the wheel cylinders of the vehicle wheels FL and FR having the first brake devices 710 in accordance with the required pressure, thereby enabling precise pressure control.

As described above, the brake system 1 may recognize the driver's braking intention on the basis of the displacement of the brake pedal 10 by simultaneously performing the braking by the hydraulic actuator and the electromechanical actuator and control the first brake device 710 and the second brake device 720 to generate the braking force on the basis of the displacement of the brake pedal 10.

In addition, the brake system 1 may perform functions, such as anti-lock braking mode control, traction control mode control, and electronic stability control mode control, by quickly and precisely controlling the pressure by using the hydraulic actuator 200 and the hydraulic circuit 400 in comparison with a case in which the braking is performed only by using the electromechanical actuators 715 and 725.

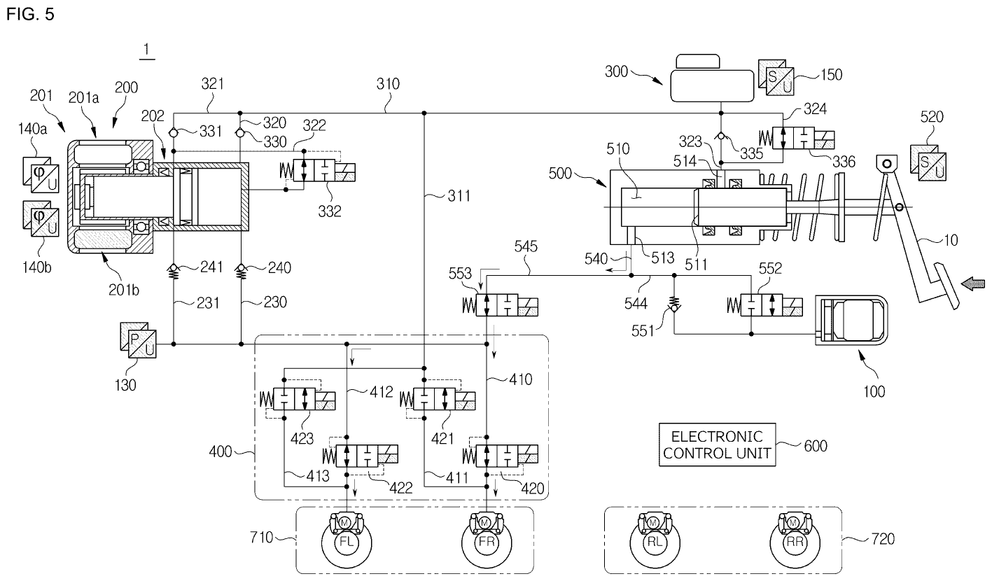

FIG. 5 is a hydraulic circuit diagram illustrating a state in which a fallback mode in which the brake system according to the first embodiment of the disclosed disclosure is not normally operated is performed.

In case that the brake system 1 is not operated normally, the valves 332, 336, 420, 421, 422, 423, and 552 are in braking initial states that are non-operating states.

When the driver presses the brake pedal 10, the master piston 511 connected to the brake pedal 10 is advanced, and the liquid pressure, which is discharged from the master cylinder 500 by pressing or moving the master piston 511, is directly transmitted to the first brake device 710 through the back-up flow path 545 connected to perform back-up braking, thereby implementing the braking force.

In this case, the cut valve 553, which is installed in the back-up flow path 545, and the plurality of inlet valves 420 and 422, which opens or closes the flow path of the hydraulic circuit 400, are configured as normal-open type solenoid valves, and the simulator valve 552 and the plurality of outlet valves 421 and 423 are configured normal-closed solenoid valves, such that the liquid pressure is transmitted directly to the first brake device 710. Therefore, stable braking may be performed, such that braking stability may be improved.

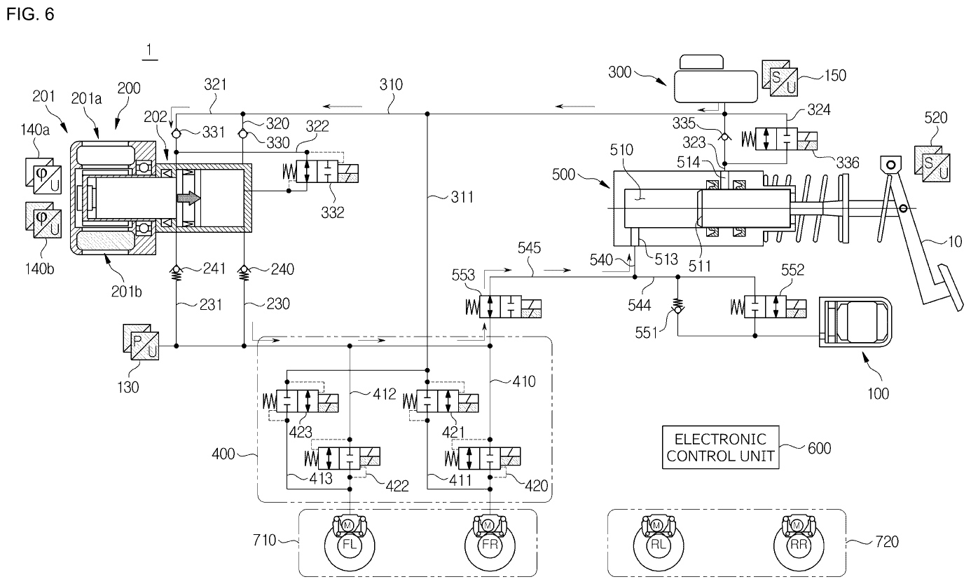

FIG. 6 is a hydraulic circuit diagram illustrating a state in which an inspection mode in which the brake system according to the first embodiment of the disclosed disclosure inspects the valve for a leak is performed.

The brake system 1 according to the first embodiment of the disclosed disclosure may operate in the inspection mode in which the brake system 1 inspects the simulator valve 552 for a leak.

As described above, in case that the brake system 1 operates abnormally, the valves 332, 336, 420, 421, 422, 423, and 552 are in the braking initial states that are non-operating states, and the cut valve 553, which is installed in the back-up flow path 545, and the first and second inlet valves 420 and 422, which are provided at the upstream sides of the wheel cylinders provided in the first brake devices 710, are opened, such that the liquid pressure is transmitted directly to the wheel cylinder.

In this case, the simulator valve 552 may be in the closed state and prevent the liquid pressure, which is transmitted to the wheel cylinder through the back-up flow path 545, from leaking through the pedal simulator 100. Therefore, the liquid pressure, which is discharged from the master cylinder 500 when the driver presses the brake pedal 10, may be transmitted to the first brake device 710 without loss, thereby ensuring stable braking.

However, in case that the simulator valve 552 leaks, a part of the liquid pressure discharged from the master cylinder 500 may be lost through the simulator valve 552. The simulator valve 552 is provided to be closed in the abnormal mode. The simulator valve 552 may leak because of pressure formed at a rear end of the simulation chamber when the liquid pressure discharged from the master cylinder 500 pushes the reaction force piston of the pedal simulator 100.

The driver cannot obtain an intended braking force when the simulator valve 552 leaks as described above. For this reason, there occurs a problem with braking stability.

The inspection mode refers to a mode that identifies whether there is a loss of pressure by generating the liquid pressure by the hydraulic actuator 200 in order to identify whether the simulator valve 552 leaks.

If a pressure loss is generated as the liquid pressure discharged from the hydraulic actuator 200 is introduced into the reservoir 300, it is difficult to identify whether the simulator valve 552 leaks.

Therefore, in the inspection mode, the inspection valve 336 may be closed, and the hydraulic circuit 400 connected to the hydraulic actuator 200 may be configured as a closed circuit. That is, the closed circuit may be configured by closing the inspection valve 336, the simulator valve 552, and the outlet valves 421 and 423 and blocking the flow path that connects the hydraulic actuator 200 and the reservoir 300.

In the inspection mode, in the initial states of the valves 332, 336, 420, 421, 422, 423, and 552 included in the brake system 1 of the present disclosure, the first and second inlet valves 420 and 422 may switch to the closed state, and the cut valve 553 may be kept in the open state, such that the liquid pressure generated by the hydraulic actuator 200 may be transmitted to the master cylinder 500.

When the inlet valves 420 and 422 are closed, the liquid pressure of the hydraulic actuator 200 may be prevented from being transmitted to the hydraulic circuit 400. When the inspection valve 336 switches to the closed state, the liquid pressure supplied to the master cylinder 500 may be prevented from leaking to the reservoir 300.

In the inspection mode, the electronic control unit 600 may detect a state, in which the simulator valve 552 leaks, by generating the liquid pressure by the hydraulic actuator 200 and then analyzing a signal transmitted from a back-up flow path pressure sensor (not illustrated) configured to measure pressure of the master cylinder 500. For example, in case that the measurement result of the back-up flow path pressure sensor indicates that there is no loss, it may be determined that the simulator valve 552 does not leak. In case that the measurement result of the back-up flow path pressure sensor indicates that there is a loss, it may be determined that the simulator valve 552 leaks.

The inspection mode may be performed under a preset condition by the electronic control unit while the vehicle travels or is stationary.

Hereinafter, a brake system according to a second embodiment of the present disclosure will be described. Hereinafter, the constituent elements identical to those in the above-mentioned embodiment will be denoted by the same reference numerals, and a detailed description thereof will be omitted.

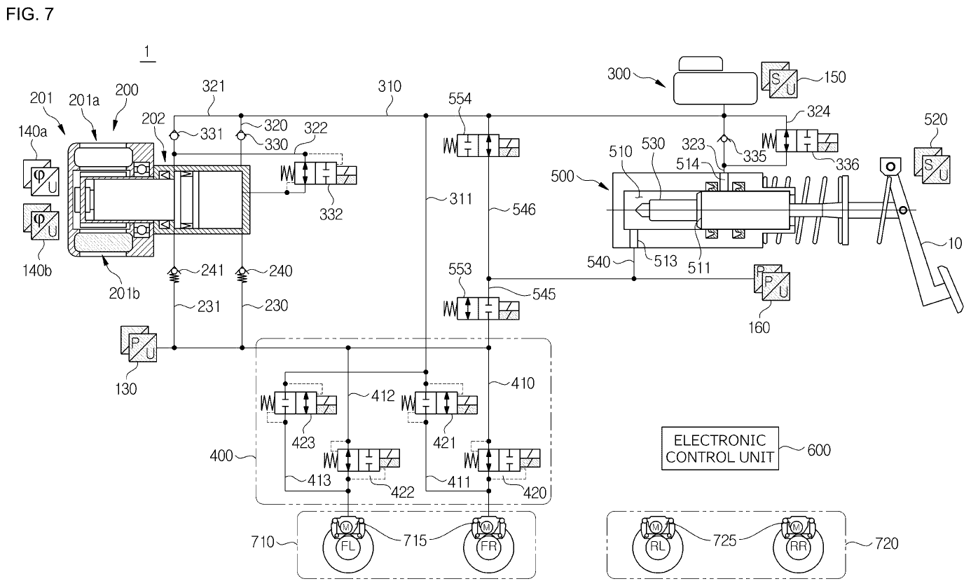

FIG. 7 is a hydraulic circuit diagram illustrating the brake system according to the second embodiment of the disclosed disclosure.

With reference to FIG. 7, the master cylinder 500 according to the second embodiment of the disclosed disclosure may be provided as an integrated master cylinder 500 including the master chamber 510, the master piston 511 provided in the master chamber 510 and provided to be displaceable by the brake pedal 10, and an elastic member 530 provided in the master chamber 510 and configured to provide a reaction force to the master piston 511 in response to the pedal effort of the brake pedal 10.

Unlike the first embodiment in which the master cylinder 500 and the pedal simulator 100 are provided separately and connected by the branch flow path 544, the present embodiment has the same configuration as the above-mentioned first embodiment, except for a configuration in which the elastic member 530 is provided in the master chamber 510 of the master cylinder 500 and provides the reaction force directly to the master piston 511, and to this end, a simulation flow path 546 configured to connect the back-up flow path 545 and the reservoir 300 is included.

The elastic member 530 is provided in the master chamber 510 and provides pedal feel by means of the elastic restoring force generated when the elastic member 530 is compressed.

One end of the elastic member 530 may be supported by the master piston 511. The elastic member 530 is provided to be compressed and deformed between the master piston 511 and an end of the master chamber 510 as the master piston 511 moves. The elastic member 530 may provide an elastic restoring force while being compressed and deformed as the master piston 511 moves.

The elastic member 530 may be made of a material such as rubber compressible and expandable in accordance with the displacement of the master piston 511.

The elastic member 530 may provide a reaction force in response to the pedal effort applied to the brake pedal 10 by the driver. In addition, on the contrary, the elastic member 530 may provide a reaction force in response to a force for releasing the pedal effort applied to the brake pedal 10 by the driver.

The driver may finely adjust the braking force in accordance with the driver's intention by providing the reaction force to the extent that the elastic member 530 compensates for the pedal effort or the force for releasing the pedal effort provided by the driver.

The simulation flow path 546 may connect the back-up flow path 545 and the reservoir 300. More specifically, one end of the simulation flow path 546 may be connected to the back-up flow path 545 between the cut valve 553 and the master cylinder 500, and the other end of the simulation flow path 546 may be connected to the first reservoir flow path 310 connected to the reservoir 300.

A simulator valve 554 is provided in the simulation flow path 546 and controls the flow of the pressing medium between the reservoir 300 and the master chamber 510. The simulator valve 554 may include a normal-closed type solenoid valve that is kept in a closed state at ordinary times. When the driver applies the pedal effort to the brake pedal 10, the simulator valve 554 is opened, such that the pressing medium of the master chamber 510 is discharged to the reservoir 300 sequentially through the first hydraulic pressure port 513, the back-up flow path 545, and the simulation flow path 546.

An operation of the integrated master cylinder 500 having the elastic member 530 will be described. When the driver applies the pedal effort to the brake pedal 10 during the normal operation, the master piston 511 moves, and the pressing medium in the master chamber 510 is transmitted to the reservoir 300 through the simulation flow path 546.

The displacement of the master piston 511 may compress the elastic member 530, and the elastic restoring force, which is generated by compressing the elastic member 530, may provide the pedal feel to the driver.

Thereafter, when the driver releases the pedal effort from the brake pedal 10, the master piston 511 is returned to an original position by a restoring force of a spring provided in the master cylinder 500 and a restoring force of the elastic member 530.

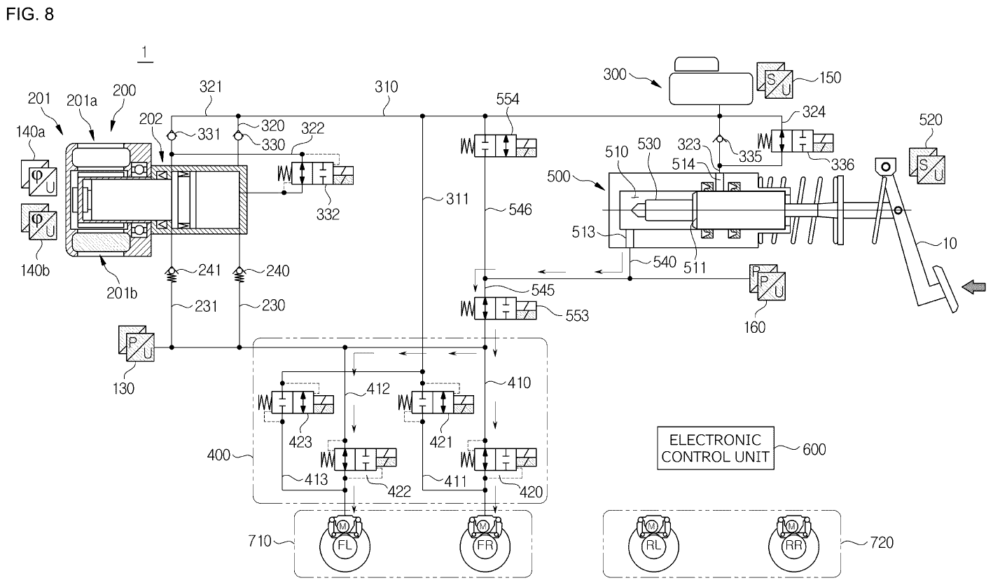

FIG. 8 is a hydraulic circuit diagram illustrating a state in which a fallback mode in which the brake system according to the second embodiment of the disclosed disclosure is not normally operated is performed.

Like the brake system 1 according to the first embodiment, the brake system 1 according to the second embodiment includes the back-up flow path 545 capable of supplying the pressing medium, which is discharged from the master cylinder 500, directly to the first brake device 710 when the brake system 1 operates abnormally. The back-up flow path 545 may branch off from the cylinder outlet flow path 540.

The cut valve 553, which controls the flow of the pressing medium, may be provided in the back-up flow path 545.

The cut valve 553 may be provided as a normal open-type solenoid valve that is opened in the normal state and operated to be closed when receiving the closing signal from the electronic control unit.

The simulation flow path 546 may connect the back-up flow path 545 and the reservoir 300.

In case that the brake system 1 is not operated normally, the valves 332, 336, 420, 421, 422, 423, 553, and 554 are in the braking initial states that are the non-operating states.

When the driver presses the brake pedal 10, the master piston 511 connected to the brake pedal 10 is advanced, and the liquid pressure, which is discharged from the master cylinder 500 by pressing or moving the master piston 511, is directly transmitted to the first brake device 710 through the back-up flow path 545 connected to perform back-up braking, thereby implementing the braking force.

In this case, the cut valve 553, which is installed in the back-up flow path 545, and the plurality of inlet valves 420 and 422, which opens or closes the flow path of the hydraulic circuit 400, are configured as normal-open type solenoid valves, and the simulator valve 554 and the plurality of outlet valves 421 and 423 are configured normal-closed solenoid valves, such that the liquid pressure is transmitted directly to the first brake device 710. Therefore, the stable braking may be performed, such that the braking stability may be improved.

Meanwhile, the brake system 1 according to the second embodiment may operate in the inspection mode in which the brake system 1 inspects the simulator valve 554 for a leak.

As in the first embodiment, in case that the brake system 1 operates abnormally, the valves 332, 336, 420, 421, 422, 423, and 552 are in the braking initial states that are non-operating states, and the cut valve 553, which is installed in the back-up flow path 545, and the first and second inlet valves 420 and 422, which are provided at the upstream sides of the wheel cylinders provided in the first brake devices 710, are opened, such that the liquid pressure is transmitted directly to the wheel cylinder.

In this case, the simulator valve 554 may be in the closed state and prevent the liquid pressure, which is transmitted to the wheel cylinder through the back-up flow path 545, from leaking to the reservoir 300 through the simulation flow path 546. Therefore, the liquid pressure, which is discharged from the master cylinder 500 when the driver presses the brake pedal 10, may be transmitted to the first brake device 710 without loss, thereby ensuring stable braking.

However, in case that the simulator valve 554 leaks, a part of the liquid pressure discharged from the master cylinder 500 may be lost through the simulator valve 554.

The driver cannot obtain an intended braking force when the simulator valve 554 leaks as described above. For this reason, there occurs a problem with braking stability.

The inspection mode refers to a mode that identifies whether there is a loss of pressure by generating the liquid pressure by the hydraulic actuator 200 in order to identify whether the simulator valve 554 leaks.

If a pressure loss is generated as the liquid pressure discharged from the hydraulic actuator 200 is introduced into the reservoir 300, it is difficult to identify whether the simulator valve 554 leaks.

Therefore, in the inspection mode, the inspection valve 336 may be closed, and the hydraulic circuit 400 connected to the hydraulic actuator 200 may be configured as a closed circuit. That is, the closed circuit may be configured by closing the inspection valve 336, the simulator valve 554, and the outlet valves 421 and 423 and blocking the flow path that connects the hydraulic actuator 200 and the reservoir 300.

Thereafter, in the inspection mode, as in the first embodiment, the electronic control unit 1 may detect a state, in which the simulator valve 554 leaks, by generating the liquid pressure by the hydraulic actuator 200 and then analyzing a signal transmitted from a back-up flow path pressure sensor 160 configured to measure pressure of the master cylinder 500.

Hereinafter, a brake system according to a third embodiment of the present disclosure will be described. Hereinafter, the constituent elements identical to those in the above-mentioned embodiment will be denoted by the same reference numerals, and a detailed description thereof will be omitted.

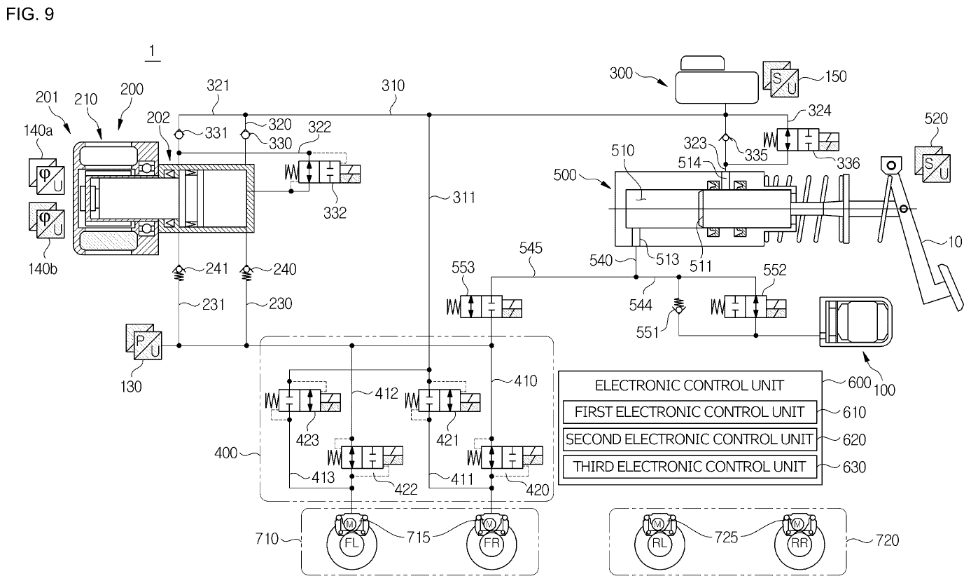

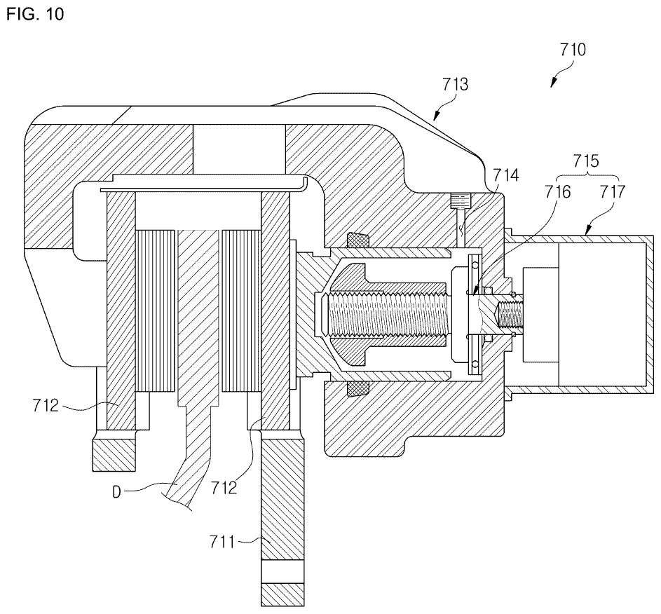

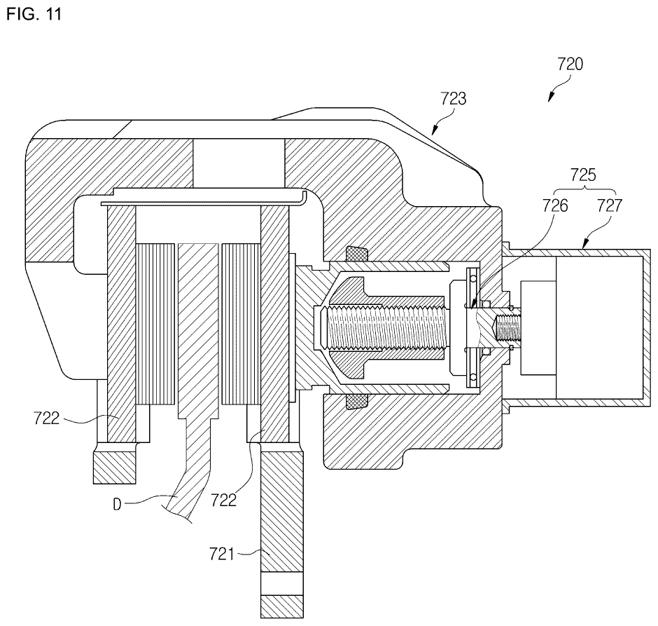

FIG. 9 is a hydraulic circuit diagram illustrating a brake system according to a third embodiment of the disclosed disclosure, FIG. 10 is a cross-sectional side view illustrating a first brake device according to the third embodiment of the disclosed disclosure, and FIG. 11 is a cross-sectional side view illustrating a second brake device according to the third embodiment of the disclosed disclosure.

With reference to FIGS. 9 to 11, the brake system 1 includes the hydraulic actuator 200 hydraulically connected to the first brake device 710 provided in the first wheel related to the first axle of the vehicle, the first motor 210 configured to operate the hydraulic actuator 200, a power transmission mechanism 726 mechanically connected to the second brake device 720 provided in the second wheel related to the second axle different from the first axle, a second motor 727 configured to operate the power transmission mechanism 726, another power transmission mechanism 716 mechanically connected to the first brake device 710, a third motor 717 configured to operate another power transmission mechanism 716, a first control unit 610 configured to control the first motor 210 to supply the liquid pressure to the first brake device 710 or recover the liquid pressure on the basis that an output signal of the pedal displacement sensor 520 of the vehicle is received, a second control unit 620 configured to control the second motor 727 to operate or release the second brake device 720 in response to a control signal on the basis of an output signal of the pedal displacement sensor 520 of the vehicle, and a third control unit 630 configured to control the third motor 717 to operate or release the first brake device 710 in response to a control signal on the basis of an output signal of the pedal displacement sensor 520 of the vehicle.

As in the first and second embodiments, the first brake device 710 may be provided in the first wheel related to the first axle of the vehicle, and the second brake device 720 may be provided in the second wheel related to the second axle different from the first axle. As illustrated in FIG. 9, the first brake devices 710 may be respectively provided in the two front wheels FL and FR of the vehicle, and the second brake devices 720 may be respectively provided in the two rear wheels RL and RR of the vehicle.

However, the present disclosure is not limited thereto. In another embodiment, the first brake devices 710 may be respectively provided in the two rear wheels RL and RR of the vehicle, and the second brake devices 720 may be respectively provided in the two front wheels FL and FR of the vehicle.

FIG. 10 illustrates an example of the first brake device 710. With reference to FIG. 10, the first brake device 710 may be operated or released by the liquid pressure supplied or recovered by the hydraulic actuator 200. To this end, the first brake device 710 may include a carrier 711 on which a pair of pad plates 712 is installed to be advanced or retracted to press a disc D configured to rotate together with the wheel of the vehicle, and a caliper housing 713 slidably installed on the carrier 711 and having a cylinder in which a piston is installed to be advanced or retracted by hydraulic braking pressure.

The liquid pressure supplied by the hydraulic actuator 200 may be introduced into the cylinder through an oil port 714 formed to communicate with the cylinder, the piston presses the inner pad plate 712 by the supplied liquid pressure, the caliper housing 713 is operated in the opposite direction to the piston by the reaction force, and a finger part presses the outer pad plate 712 against the disc D, such that the braking may be performed.

Meanwhile, the first brake device 710 may be operated or released by another power transmission mechanism 716. The second electromechanical actuator 715 including the third motor 717 and another power transmission mechanism 716 may press the above-mentioned piston.

With reference to FIG. 10, the piston presses the inner pad plate 712 against the disc D by an axial force of the power transmission mechanism 716 that receives a rotational force of the third motor 717. The power transmission mechanism 716 may have a nut member installed to be disposed in the piston and provided to be in contact with the piston, and a spindle member screw-coupled to the nut member.

The nut member is disposed in the piston in a state in which a rotation of the nut member is restricted. The nut member is screw-coupled to the spindle member. Therefore, the nut member serves to press or release the piston while being advanced or retracted in the rotation directions of the spindle member.

As described above, the first brake device 710 may perform the braking by the first motor 210 of the hydraulic actuator 200 or the third motor 717 of the second electromechanical actuator 715.

FIG. 11 illustrates an example of the second brake device 720.

The second brake device 720 may have a configuration similar to that of the first brake device 710 in FIG. 10.

The second brake device 720 may be operated or released by the first electromechanical actuator 725 including the second motor 727. With reference to FIG. 11, the second brake device 720 may include a carrier 721 on which a pair of pad plates 722 is installed to be advanced or retracted to press the disc D configured to rotate together with the wheel of the vehicle, and a caliper housing 723 slidably installed on the carrier 721 and having a cylinder in which a piston is installed to be advanced or retracted by the first electromechanical actuator 725.

Like the first brake device 710, in the second brake device 720, the piston presses the inner pad plate 722 against the disc D by an axial force of the power transmission mechanism 726 that receives a rotational force of the second motor 727. The power transmission mechanism 726 may have a nut member installed to be disposed in the piston and provided to be in contact with the piston, and a spindle member screw-coupled to the nut member.

Because the configuration of the power transmission mechanism 726 is identical to the configuration of the power transmission mechanism 716 of the first brake device 710, a detailed description thereof will be omitted.

The hydraulic actuator 200 may be hydraulically connected to the first brake device 710 and operated by the first motor 210. The hydraulic actuator 200 may supply the liquid pressure to the first brake device 710 or recover the liquid pressure by the operation of the first motor 210. As described above in the first and second embodiments, the hydraulic actuator 200 may include a piston-cylinder unit connected to the first motor 210 and supply the liquid pressure. Alternatively, in another embodiment, the hydraulic actuator 200 may include a pump connected to the first motor 210 and supply the liquid pressure.

The first control unit 610 may control the first motor 210 so that the first brake device 710 may be operated or released. In this case, the first control unit 610 may be connected directly to the pedal displacement sensor 520 and control the first motor 210 on the basis that the output signal of the pedal displacement sensor 520 is received.

The second control unit 620 may operate or release the second brake device 720 by controlling the second motor 727. In this case, the second control unit 620 may not be connected directly to the pedal displacement sensor 520, and the second control unit 620 may control the second motor 727 in response to the control signal on the basis of the output signal of the pedal displacement sensor 520 of the vehicle.

The second control unit 620 may receive the control signal from the first control unit 610. That is, the first control unit 610 connected directly to the pedal displacement sensor 520 may generate the control signal while simultaneously controlling the first motor 210 of the hydraulic actuator 200 on the basis of the output signal of the pedal displacement sensor 520. The second control unit 620, which receives the control signal, may control the second motor 727 of the first electromechanical actuator 725.

Alternatively, the second control unit 620 may receive the control signal from the separate third control unit 630 provided in the vehicle. That is, the second control unit 620 may control the second motor 727 by receiving the control signal from the separate third control unit 630 instead of the first control unit 610 connected directly to the pedal displacement sensor 520.

Meanwhile, in the present embodiment, the third control unit 630 may not be connected directly to the pedal displacement sensor 520.

In this case, the third control unit 630 may be provided to control the third motor 717 of the second electromechanical actuator 715 of the first brake device 710. The third control unit 630 may operate or release the first brake device 710 by controlling the third motor 717. In this case, the third control unit 630 may not be connected directly to the pedal displacement sensor 520, and the third control unit 630 may control the third motor 717 in response to the control signal on the basis of the output signal of the pedal displacement sensor 520 of the vehicle.

The third control unit 630 may receive the control signal from the first control unit 610. That is, the first control unit 610 connected directly to the pedal displacement sensor 520 may generate the control signal while simultaneously controlling the first motor 210 of the hydraulic actuator 200 on the basis of the output signal of the pedal displacement sensor 520. The third control unit 620, which receives the control signal, may control the third motor 717 of the second electromechanical actuator 715.

As described above, the embodiments have been described with reference to the accompanying drawings. A person skilled in the art may understand that the disclosed disclosure may be carried out in other forms different from those disclosed in the embodiments without changing the technical spirit or the essential features of the disclosed disclosure. The disclosed embodiments are illustrative and should not be interpreted as being restrictive.

What is claimed is:

1. A brake system for a vehicle, the brake system comprising:
first brake devices respectively provided in two vehicle wheels of a vehicle and configured to perform a braking operation by transmitted liquid pressure;
second brake devices respectively provided in the other two vehicle wheels of the vehicle and configured to perform a braking operation by an embedded first electromechanical actuator;
a reservoir configured to store a pressing medium;
a master cylinder comprising a master chamber, and a master piston provided in the master chamber and provided to be displaceable by a brake pedal;
a hydraulic actuator configured to generate the liquid pressure by an electrical signal outputted in response to a displacement amount of the brake pedal;
a hydraulic circuit configured to control the liquid pressure to be transmitted to the first brake device; and
an electronic control unit configured to control the first electromechanical actuator, the hydraulic actuator, and the hydraulic circuit so that the first brake device and the second brake device generate braking forces in response to the displacement amount of the brake pedal.

2. The brake system of claim 1, further comprising:
a pedal simulator configured to provide a reaction force in response to a pedal effort of the brake pedal.

3. The brake system of claim 1, wherein the master cylinder further comprises an elastic member provided in the master chamber and configured to provide a reaction force to the master piston in response to a pedal effort of the brake pedal.

4. The brake system of claim 1, wherein any one of the first brake device and the second brake device is provided in each of two front wheels of the vehicle, and the other of the first brake device and the second brake device is provided in each of two rear wheels of the vehicle.

5. The brake system of claim 1, wherein the first brake device performs the braking operation by any one of the transmitted liquid pressure and an embedded second electromechanical actuator.

6. The brake system of claim 5, wherein the first brake device performs the braking operation simultaneously by the transmitted liquid pressure and the embedded second electromechanical actuator.

7. The brake system of claim 1, wherein the hydraulic circuit comprises a plurality of valves disposed in a flow path that connects the hydraulic actuator and the first brake device, and
wherein the electronic control unit controls the plurality of valves to generate the braking force by transmitting the pressing medium, which is discharged from the hydraulic actuator, to the first brake device on the basis of the displacement amount of the brake pedal.

8. The brake system of claim 7, further comprising:
a back-up flow path connected to supply the pressing medium, which is discharged from the master cylinder, to the first brake device; and
a cut valve provided in the back-up flow path.

9. The brake system of claim 1, further comprising:
a pedal simulator configured to provide a reaction force in response to a pedal effort of the brake pedal; and
a simulator valve provided in a branch flow path configured to connect the pedal simulator and the master cylinder,
wherein the electronic control unit switches the simulator valve to an open state when a driver applies the pedal effort to the brake pedal.

10. The brake system of claim 8, further comprising:
a simulator valve provided in a simulation flow path configured to connect the back-up flow path and the reservoir,
wherein the master cylinder further comprises an elastic member provided in the master chamber and configured to provide a reaction force to the master piston in response to a pedal effort of the brake pedal, and
wherein the electronic control unit switches the simulator valve to an open state when a driver applies the pedal effort to the brake pedal.

11. The brake system of claim 9, wherein the electronic control unit switches the simulator valve to a closed state while an inspection mode is performed in which the simulator valve is inspected for a leak.

12. The brake system of claim 9, further comprising:
a reservoir flow path configured to allow the reservoir and the master cylinder to communicate with each other;
a reservoir check valve provided in the reservoir flow path;
a bypass flow path configured to connect front and rear sides of the reservoir check valve; and
an inspection valve provided in the bypass flow path.

13. The brake system of claim 12, wherein the electronic control unit switches the inspection valve to a closed state while an inspection mode is performed in which the inspection valve is inspected for a leak.

14. A brake system for a vehicle, the brake system comprising:
first brake devices respectively provided in two vehicle wheels of a vehicle and configured to perform a braking operation by transmitted liquid pressure;
second brake devices respectively provided in the other two vehicle wheels of the vehicle and configured to perform a braking operation by an embedded electromechanical actuator;
a reservoir configured to store a pressing medium;
a master cylinder comprising a master chamber, and a master piston provided in the master chamber and provided to be displaceable by a brake pedal;
a hydraulic actuator configured to generate the liquid pressure by an electrical signal outputted in response to a displacement amount of the brake pedal;
a hydraulic circuit configured to control the liquid pressure to be transmitted to the first brake device;
a first electronic control unit configured to control the hydraulic actuator and the hydraulic circuit so that the first brake device generates a braking force in response to the displacement amount of the brake pedal; and
a second electronic control unit configured to control the electromechanical actuator so that the second brake device generates a braking force in response to the displacement amount of the brake pedal.

15. A brake system for a vehicle, the brake system comprising:
a hydraulic actuator hydraulically connected to a first brake device provided in a first wheel related to a first axle of a vehicle;
a first motor configured to operate the hydraulic actuator;
a power transmission mechanism mechanically connected to a second brake device provided in a second wheel related to a second axle different from the first axle;
a second motor configured to operate the power transmission mechanism;
a first control unit configured to control the first motor to supply liquid pressure to the first brake device or recover the liquid pressure on the basis that an output signal of a pedal displacement sensor of the vehicle is received; and
a second control unit configured to control the second motor to operate or release the second brake device in response to a control signal on the basis of the output signal of the pedal displacement sensor of the vehicle,
wherein the first control unit is connected directly to the pedal displacement sensor, and
wherein the second control unit is not connected directly to the pedal displacement sensor.

16. The brake system of claim 15, wherein the second control unit receives the control signal from the first control unit.

17. The brake system of claim 15, wherein the second control unit receives the control signal from a third control unit provided in the vehicle.

18. The brake system of claim 15, wherein the first brake device is operated or released by the liquid pressure supplied or recovered by the hydraulic actuator.

19. The brake system of claim 15, further comprising:
another power transmission mechanism mechanically connected to the first brake device;
a third motor configured to operate another power transmission mechanism; and
a third control unit configured to control the third motor to operate or release the first brake device in response to a control signal on the basis of the output signal of the pedal displacement sensor of the vehicle,
wherein the third control unit is not connected directly to the pedal displacement sensor.

20. The brake system of claim 19, wherein the first brake device is operated or released by the liquid pressure supplied or recovered by the hydraulic actuator, and the first brake device is operated or released by another power transmission mechanism.
